(19) United States
(12) Patent Application Publication
(10) Pub. No.: US 2005/0171961 A1
(43) Pub. Date: Aug. 4, 2005

(54) Fingerprinting software applications

(75) Inventors: Aaron L. Culbreth, Bellevue, WA (US); Roderick M. Toll, Sammamish, WA (US); James A. Hall, Bellevue, WA (US); Thomas Brian Springer JR., Redmond, WA (US); Wei Wei Ada Cho, Bellevue, WA (US); C. Shane Evans, Duvall, WA (US)

Correspondence Address: KLARQUIST SPARKMAN LLP, 121 S.W. SALMON STREET, SUITE 1600, PORTLAND, OR, 97204, US

(73) Assignee: Microsoft Corporation

(21) Appl. No.: 10/769,075

(22) Filed: Jan. 30, 2004

(51) Int. Cl. G06F 7/00

(52) U.S. Cl. 707/100

(57) ABSTRACT

Techniques and tools are described for creating and using application identifiers that act as “fingerprints” for applications. In one aspect, an identifier generation algorithm is applied to application data and an application identifier is generated. The application data comprises graphical icon data, and can further comprise other data (e.g., executable name, registry data). The identifier generation algorithm can be a hashing algorithm that generates a hash value. The application identifier can be sent in a database query, and a database can return results indicating, for example, whether metadata can be obtained from a metadata service, or whether the software application is of a particular type (e.g., a gaming-related application). Application identifiers can be stored, for example, in a data file along with one or more other application identifiers for other software applications. Described techniques and tools can be used in a graphical user interface-based gaming activity center.

### TECHNICAL FIELD

The invention relates generally to generating and using software application identifiers.

### BACKGROUND

Modern personal computers (PCs) are capable of storing many more applications than their earlier counterparts. With their expanded storage capacity, modern PCs are capable of storing hundreds of executable applications simultaneously, and these applications can be found in many different locations in the PC's file system. While some PC users may manage their applications carefully enough to know what applications are stored on their PCs and where those applications are located, other users are not aware of all the applications stored on their PCs, and may need help to locate and run even their most frequently-used applications. Even experienced PC users may have difficulty finding an infrequently-used application among a large collection of files.

In response to the increasing numbers of applications stored on PCs, different solutions have been developed to help users find the applications they are looking for. Microsoft Corporation's Windows family of operating systems employ graphical user interface (GUI) tools for visually exploring the contents of hard drives and network drives in order to allow users to locate and run applications. For example, a PC user can search for an application on the PC's hard drive by typing a few letters of the application's file name into a search window, by browsing visually through different folders in the PC's file system, or by navigating through a collection of application shortcuts such as those provided in the Start Menu found in the Windows operating systems.

Although such tools improve a user's ability to find applications, situations often arise where users are still unable to easily locate applications or are unable to distinguish between different applications. For example, if an application is stored on a computer without a shortcut accessible from the desktop, the user is required to know a lot of information about an application and the PC's file system in order to find the application. A user may know that she wishes to play a game called “Minesweeper,” but if a previously existing shortcut to the game is accidentally deleted, she may have difficulty finding the game if she does not know the game's filename or its location in the file system. Even if a user knows an application's file name, she may have difficulty finding the correct application if the application's executable name isn't distinctive enough to differentiate it from another application. For example, if the user is looking for an application with a common filename such as “game.exe,” it may be difficult for the user to find the correct application if there are other applications in the file system having the same filename. Even automated searches performed by a computer can produce unreliable results when file names are confusingly similar.

Whatever the benefits of previous techniques, they do not have the advantages of the following tools and techniques.

### SUMMARY

In summary, techniques and tools are described for creating and using application identifiers that act as “fingerprints” for applications. Described techniques and tools can be used to, for example, verify whether applications on a computer are of a particular type, obtain metadata for applications, etc.

In one aspect, an identifier generation algorithm is applied to application data for a software application (such as a game or some other application) and an application identifier (e.g., a unique fixed-length string) is generated for the software application. The application data comprises graphical icon data for the software application. Alternatively, the application data can further comprise other data such as an executable name or registry data. The application identifier distinguishes the software application from other software applications on a computer system. The identifier generation algorithm can be a hashing algorithm (such as a one-way hashing algorithm) that generates a hash value. The graphical icon data can be obtained from an application binary or from some other source (e.g., an icon file). The application identifier can be sent in a database query, and a database can return results indicating, for example, whether metadata relating to the software application can be obtained from a metadata service, or whether the software application is of a particular application type (e.g., a gaming-related application). The application identifier also can be used to determine other attributes (such as parental control ratings) of the software application. The application identifier can be stored, for example, in a data file along with one or more other application identifiers for other software applications. Described techniques and tools can be used in a graphical user interface-based gaming activity center.

### BRIEF DESCRIPTION OF THE DRAWINGS

FIG. 1 is a block diagram of a suitable computing environment for implementing techniques and tools for generating and/or using application identifiers.

FIG. 2 is a flow diagram of a technique for generating an application identifier from application-specific binary data.

FIG. 3 is a block diagram of a system for generating application identifiers from an application-specific binary data block.

FIG. 4 is a block diagram of a system for generating application identifiers from an application-specific distinct binary data block comprising icon binary data and executable name.

FIG. 5 is a flow diagram of a technique for performing a database query using an application identifier.

FIG. 6 is a system diagram of a database query system using application identifiers.

FIG. 7 is a diagram of a graphical user interface for a gaming activity center comprising a game library window and a game details window.

FIGS. 8A and 8B are flow diagrams of a technique for performing automatic and manual searches for games using application identifiers.

FIG. 9 is a flow diagram of a technique for requesting game metadata using application identifiers.

### DETAILED DESCRIPTION

The following description is directed to techniques and tools for creating and using application identifiers that are distinctive enough to differentiate applications from one another. The application identifiers act as “fingerprints” for applications. Described techniques and tools can be used to verify, for example, whether applications on a computer are of a particular type (e.g., gaming-related applications, or some other type of application) by checking application identifiers against a database of known applications of that type (e.g., gaming-related applications).

Described techniques and tools include techniques and tools for creating unique application identifiers by hashing application data. For example, a unique fixed-length string can be created by applying a one-way hashing algorithm to graphical icon data and the name of the application executable. The unique fixed-length string acts as a fingerprint of the application that can then be used for later reference, e.g. in a database lookup.

In an exemplary implementation, a gaming activity center provides a central hub for a user to access and manage games on a PC. To accurately identify games, the gaming activity center checks application identifiers assigned to applications on the PC. For example, the gaming activity center can collect application identifier information when it is launched on a PC with previously-installed games, when new games are installed, or at some other time. The application identifiers can be checked against a list in a database of gaming software applications to verify whether the applications are to be included in a list of games in the gaming activity center.

II. Computing Environment

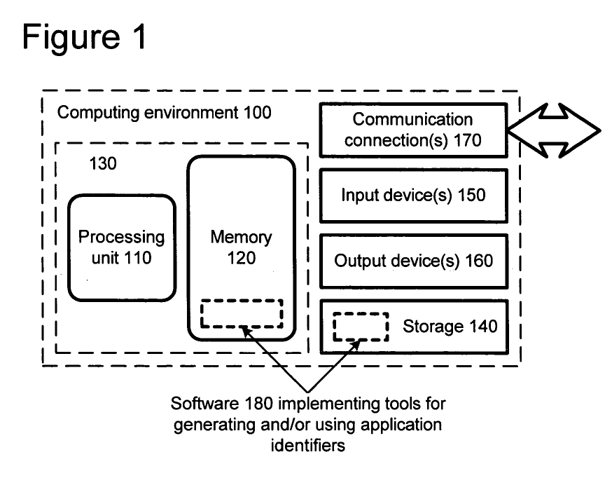

The techniques and tools described above can be implemented on any of a variety of computing devices and environments, including computers of various form factors (personal, workstation, server, handheld, laptop, tablet, or other mobile), distributed computing networks, and Web services, as a few general examples. The techniques and tools can be implemented in hardware circuitry, as well as in software 180 executing within a computer or other computing environment, such as shown in FIG. 1.

FIG. 1 illustrates a generalized example of a suitable computing environment 100 in which described techniques and tools can be implemented. The computing environment 100 is not intended to suggest any limitation as to scope of use or functionality of the invention, as the present invention may be implemented in diverse general-purpose or special-purpose computing environments.

With reference to FIG. 1, the computing environment 100 includes at least one processing unit 110 and memory 120. In FIG. 1, this most basic configuration 130 is included within a dashed line. The processing unit 110 executes computer-executable instructions and may be a real or a virtual processor. In a multi-processing system, multiple processing units execute computer-executable instructions to increase processing power. The memory 120 may be volatile memory (e.g., registers, cache, RAM), non-volatile memory (e.g., ROM, EEPROM, flash memory, etc.), or some combination of the two. The memory 120 stores software 180 implementing tools for generating and/or using application identifiers.

A computing environment may have additional features. For example, the computing environment 100 includes storage 140, one or more input devices 150, one or more output devices 160, and one or more communication connections 170. An interconnection mechanism (not shown) such as a bus, controller, or network interconnects the components of the computing environment 100. Typically, operating system software (not shown) provides an operating environment for other software executing in the computing environment 100, and coordinates activities of the components of the computing environment 100.

The storage 140 may be removable or non-removable, and includes magnetic disks, magnetic tapes or cassettes, CD-ROMs, CD-RWs, DVDs, or any other medium which can be used to store information and which can be accessed within the computing environment 100. For example, the storage 140 stores instructions for implementing software 180.

The input device(s) 150 may be a touch input device such as a keyboard, mouse, pen, or trackball, a voice input device, a scanning device, or another device that provides input to the computing environment 100. For audio, the input device(s) 150 may be a sound card or similar device that accepts audio input in analog or digital form, or a CD-ROM reader that provides audio samples to the computing environment. The output device(s) 160 may be a display, printer, speaker, CD-writer, or another device that provides output from the computing environment 100.

The communication connection(s) 170 enable communication over a communication medium to another computing entity. The communication medium conveys information such as computer-executable instructions, audio/video or other media information, or other data in a modulated data signal. By way of example, and not limitation, communication media include wired or wireless techniques implemented with an electrical, optical, RF, infrared, acoustic, or other carrier.

Techniques and tools described herein can be described in the general context of computer-readable media. Computer-readable media are any available media that can be accessed within a computing environment. By way of example, and not limitation, with the computing environment 100, computer-readable media include memory 120, storage 140, communication media, and combinations of any of the above.

Some techniques and tools herein can be described in the general context of computer-executable instructions, such as those included in program modules, being executed in a computing environment on a target real or virtual processor. Generally, program modules include functions, programs, libraries, objects, classes, components, data structures, etc. that perform particular tasks or implement particular abstract data types. The functionality of the program modules may be combined or split between program modules as desired. Computer-executable instructions may be executed within a local or distributed computing environment.

II. Fingerprinting Software Applications with Application Identifiers

Techniques and tools for creating an using identifiers for software applications are described. The identifiers act as “fingerprints” for applications and are distinctive enough to differentiate software applications from one another. In one implementation, the identifiers are unique fixed-length strings generated by hashing application data. For example, a unique fixed-length string can be created by applying a one-way hashing algorithm to a combination of graphical icon data for the application and the name of the application executable. The unique fixed-length string can then be used for later reference, e.g. in a database lookup.

A. Generating Application Identifiers

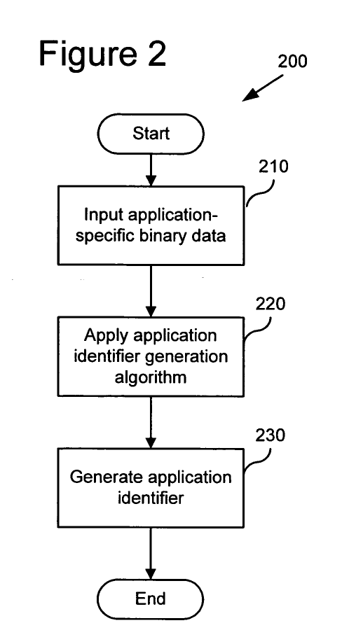

FIG. 2 is a flow diagram of a technique 200 for generating application identifiers. At 210, application-specific binary data is taken as input. At 220, an application identifier generation algorithm is applied to the application-specific binary data. At 230, the application identifier generation algorithm generates an application identifier. The application identifier acts as a fingerprint for the application.

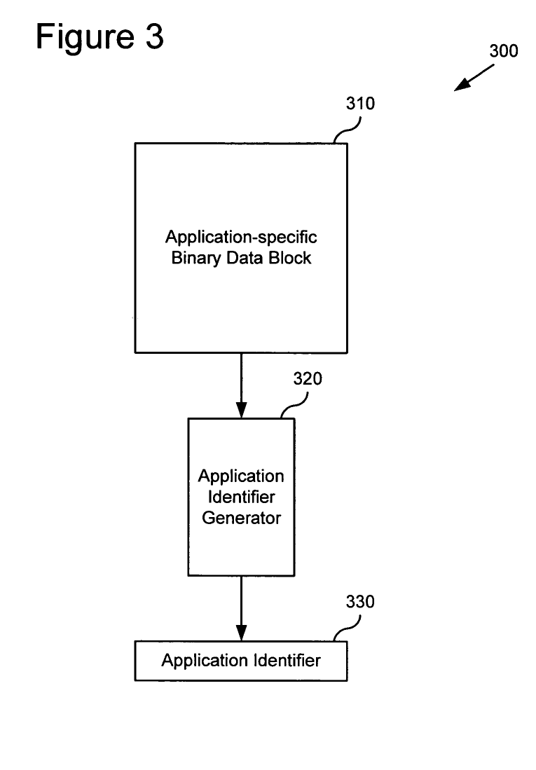

FIG. 3 is a block diagram of an application identifier generation system 300. The application-specific distinct binary data block 310 is data associated with application for which the identifier is to be generated. This data can be extracted from the application binary (e.g., an application in a portable executable file format, or some other format) or can be obtained from some other source. For example, icon data can be extracted from the application binary or obtained from an external icon file. The application identifier generator 320 takes the application-specific distinct binary data block 310 as input, and employs an application identifier generation algorithm to generate an application identifier 330. The particular application identifier generation algorithms vary depending on implementation. For example, in one implementation, the application identifier generator employs a hashing algorithm to generate a hash value that acts as a unique identifier for the application.

A hashing algorithm creates a hash value that uniquely identifies the block of data to which it is assigned. The hash values act as a fingerprint of a file, message, or other block of data. Hashing algorithms are characterized by the relative ease with which hash values can be computed given a block of data. One-way hashing algorithms are further characterized by the relative difficulty of computing the block of data given its hash value. In cryptography, a one-way hashing algorithm assigns a hash value such that the receiver of the hash value is not able to decipher the block of data to which it is assigned, given only the assigned hash value.

An application identifier generator such as the one shown in FIG. 3 can use any hashing algorithm, including, but not limited to, widely used one-way hashing algorithms. Existing one-way hashing algorithms that can be used by an application identifier generator include the MD2, MD4, MD5, SHA, RIPE-MD, and HAVAL algorithms.

Hashing algorithms produce a fixed-length output. In data encryption, one-way hashing algorithms generate hash values having 128 bits or more to help ensure that the data to which the hash value is assigned remains secure. However, longer hash values are possible, and shorter-length hash values, while less secure, can still be used as unique identifiers. In one implementation, a one-way hashing algorithm produces a 20-byte (160-bit) hash value as the application identifier. In some cases, the length of the hash value varies depending on the particular hashing algorithm used to produce it.

For more information on one-way hashing algorithms, see, e.g., William Stallings, Cryptography and Network Security: Principles and Practice (Prentice Hall, 2d ed. 1999) and Bruce Schneier, Applied Cryptography (John Wiley & Sons 1994), which are incorporated herein by reference.

Described techniques and tools can use any of the one-way hashing algorithms described above, or other application identifier generation algorithms. For example, in one implementation, one or more hashing functions included in Microsoft Corporation's Cryptography API (CryptoAPI) are used. For more information, see Microsoft Corporation's Cryptography API Software Developer's Kit.

In one implementation, the application-specific data used in the creation of the application identifier is a combination of the executable's primary icon binary data with the executable's name. This combination provides a distinctive block of data from which to compute a hash value. This data is then run through a one-way hashing algorithm to create a unique fixed length string.

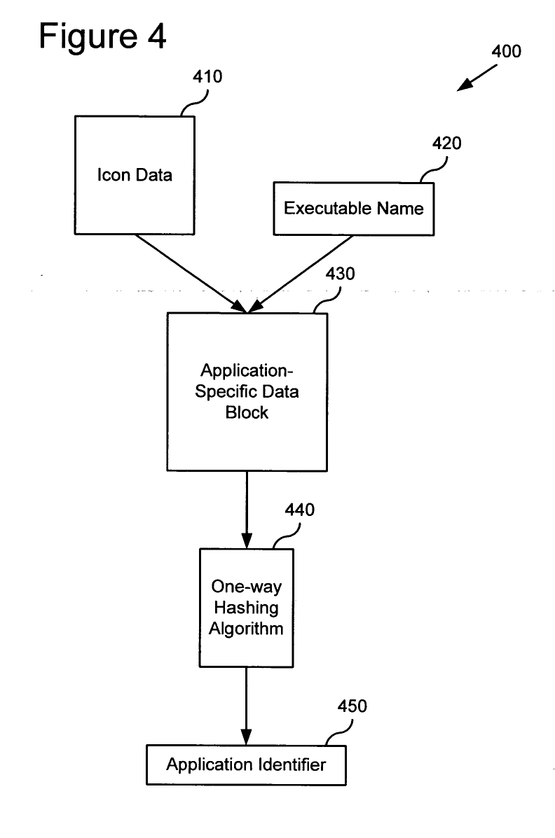

FIG. 4 is a block diagram of a system 400 for generating application identifiers from an application-specific data block 430 comprising icon data 410 and a name for the application executable 420. In the example shown in FIG. 4, the one-way hashing algorithm 440 is applied to the application-specific data block 430 and generates the application identifier 450.

Because applications often have several different icons associated with them, not all of the icon data need be used to form the application-specific block of data in a system such as the one shown in FIG. 4. For example, if an application binary contains 12 different icons of different sizes or resolutions, some subset of the icons (e.g., icons that are distinctive and unlikely to change in revisions to the application) can be used to form the block of data. As another example, if one or more external icon files are associated with the application, data in the icon files can be omitted from the application-specific data block, or can be used instead of or in combination with icon data in the application binary.

Other application-specific data also can be used. For example, a hashing algorithm could be applied to a combination of icon data and some other application-specific data, such as a shortcut name or other data that is not likely to change after the application has been installed. Or, icon data could be used without being combined with other data. Registry information also can be used to form a distinctive block of application data to which an identifier generation algorithm can be applied.

B. Using Application Identifiers

Application identifiers can be stored in different locations in a computer system. For example, multiple application identifiers can be stored in a single file on a computer system that has been designated to store application identifiers. Alternatively, application identifiers can be stored in separate files or embedded in application files. Other storage arrangements also can be used. In one implementation, application identifiers for applications on a PC are stored in a single file located in a user's personal “documents and settings” folder.

Once an application identifier has been located, the application identifier can be used to perform operations relating to the application it identifies, such as checking the application identifier against a list of applications in a database. For example, a computer can obtain an application identifier, send a query to a database and receive a result based on the query from the database.

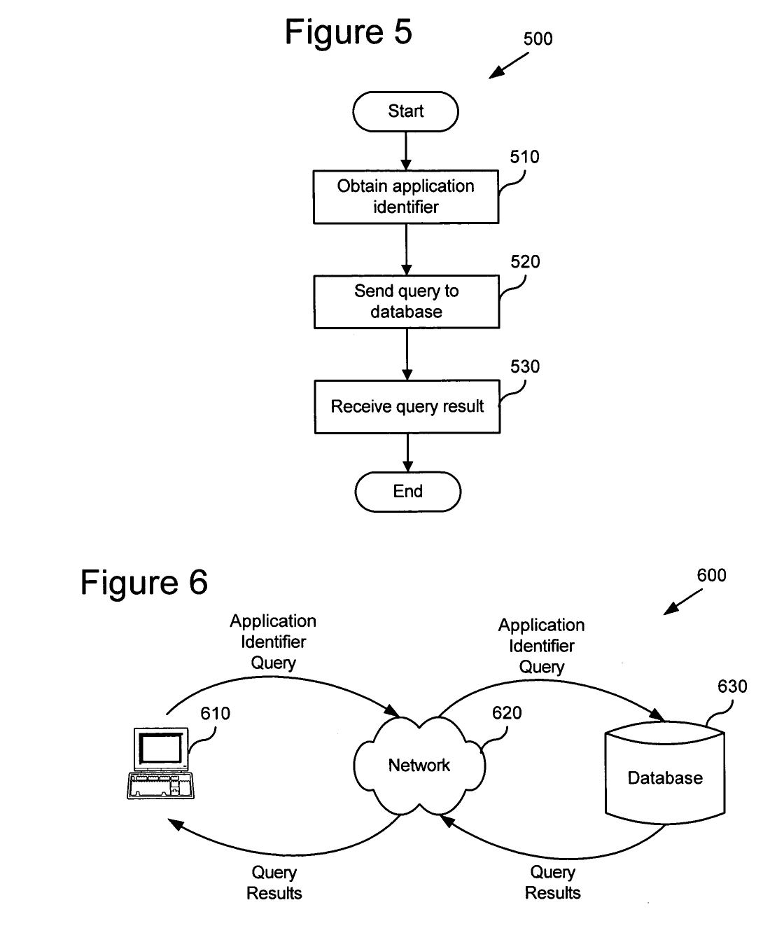

FIG. 5 is a flow diagram of a technique 500 for performing a database query using an application identifier. In the example shown in FIG. 5, at 510 a computer obtains an application identifier associated with an application. At 520, the computer sends a query to a database, and at 530, the computer receives a query result from the database.

For example, a computer can send a query to a database that maintains a list of applications of a particular type. In response to the query, the database can return a query result that indicates whether the application is of a certain type. In one implementation, a computer obtains application identifiers from applications stored on the computer itself, and sends queries to a database that maintains a list of gaming-related applications. The database then returns results that indicate whether the applications associated with the application identifiers are gaming-related applications. The computer can perform operations based on the results received from the database. In one implementation, a computer determines whether to add applications to a list of games in a gaming activity center based on the results received from the database.

Alternatively, the computer can obtain identifiers from applications stored on other computers or storage devices. As another alternative, the database can return results that indicate some other characteristic of the application or provide some other kind of information associated with the application. For example, the database can return results that indicate a parental control rating for a gaming-related application, or the database can send metadata relating to the application (such as developer name, publisher name, support information, a description of the application, etc.).

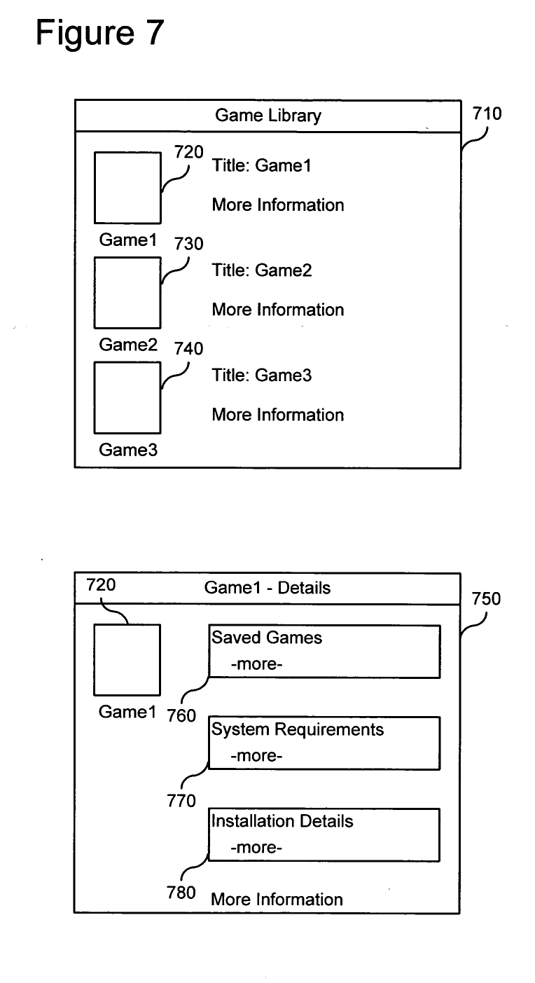

FIG. 6 is a system diagram showing a system for making application identifier database queries. A computer 610 sends a query containing application identifier information via a network 620 (e.g., a local-area network or wide-area network such as the Internet) to a database 630. The database 630 then returns query results 620 via the network to the computer 610. Although the system shown in FIG. 6 shows a computer sending a query to a remote database over a network, other arrangements are possible. For example, a computer could query a database local to the computer itself (e.g., a database on local fixed or removable storage media).

III. Exemplary Implementation

In an exemplary implementation, an operating system includes a gaming activity center for games and gaming-related applications. The gaming activity center provides a central hub for a user to access and manage games on a PC. The gaming activity center employs one or more of the described techniques and tools. In this example, the term “fingerprint” refers an application identifier that has been created using one or more of the application identifier generation techniques described herein.

For example, to accurately identify games on a PC, the gaming activity center checks application fingerprints assigned to applications on the PC. The gaming activity center can collect application fingerprint information when it is launched on a PC with previously-installed games, when new games are installed, or at some other time. The application fingerprints can be checked against a database of gaming software applications to verify whether the applications are to be included in a list of games in the gaming activity center. Described techniques and tools can be used within this exemplary implementation or in other implementations.

In this example, the gaming activity center allows users to find, manage and play games. The gaming activity center allows games to be located and launched quickly and easily. The gaming activity center includes features for collecting game information, organizing games, and displaying gaming-related software applications installed on a user's computer system. Users can perform tasks such as adding or removing game applications; sorting, viewing or grouping game applications within a list of games; and loading saved games. The gaming activity center also provides links to allow users to access game publisher websites, forums, demos, purchasing sites, etc., and can be used to play games locally or over a network.

The gaming activity center provides a “virtual view” of the games on the user's system. The game applications themselves can be installed anywhere on the system. The user can change the display of the games list to fit their preferences. For example, the user can sort games by name, genre, publisher, product family, or game content rating.

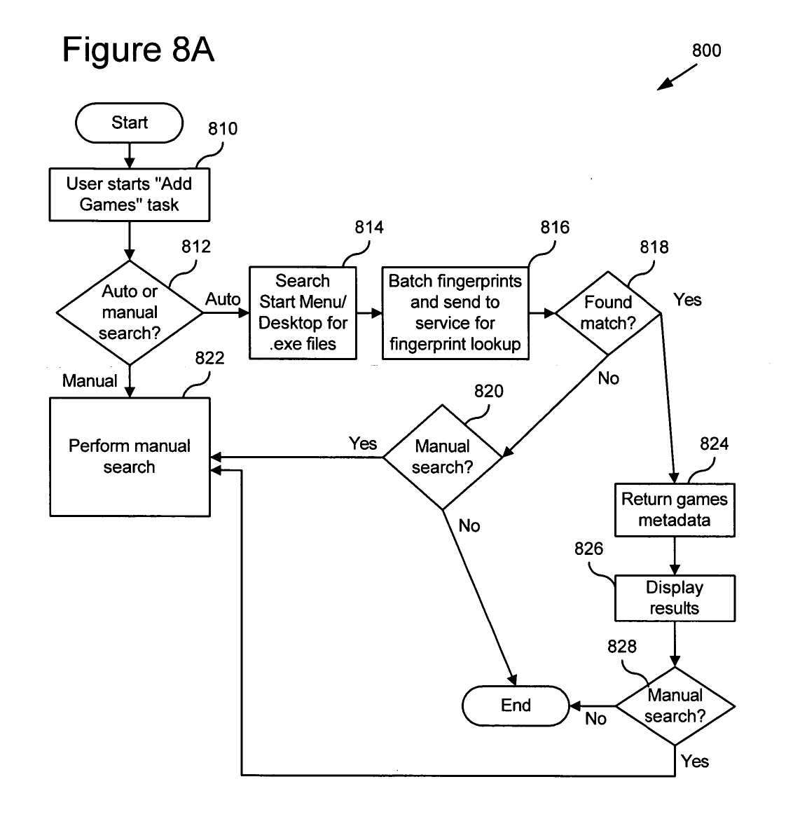

FIG. 7 is a diagram of a graphical user interface for a gaming activity center comprising a “game library” window 710 and a game details window 750. The game library window 710 includes a listing of games. The listed games have associated game icons 720, 730 and 740. The games list initially displays a limited amount of information about the games installed on the user's system. In this example, if a user desires more detailed game information, she can access game details by selecting “Details” on a right-click menu associated with a game tile displayed in the games list. Game detail window 750 includes an example of a game detail page for “Game1.”

Detailed information is presented within collapsible display modules (e.g., display modules 760, 770 and 780) hosted within the detail page. Each display module is labeled and contains categories of game-related information, such as system requirements; installation details such as install folder, size on disk, date installed, etc.; patch history; save game summary; personal screenshots; preferred input device assignment, etc.

The gaming activity center can make a request for additional metadata using a specialized globally unique identifier (“GUID”) (e.g., a Windows Metadata & Internet Services ID (“WMID”)) for referencing an application when communicating with the Games Metadata Service. After the identification of the game has been established, all further metadata requests can be executed using this GUID.

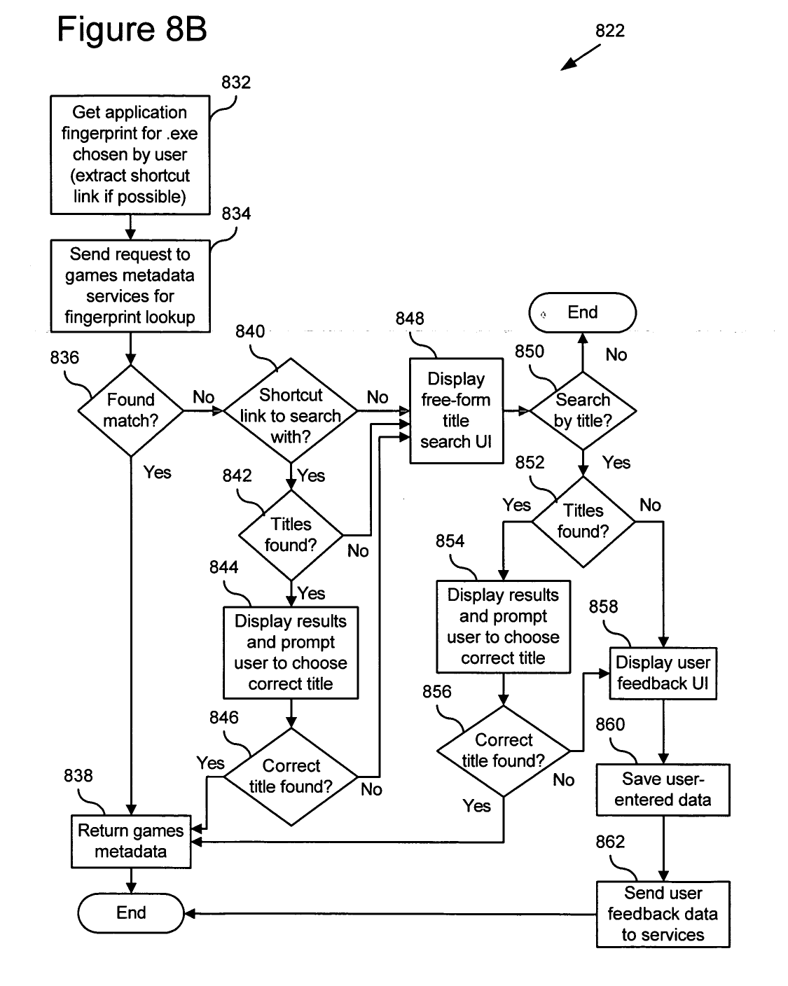

FIGS. 8A and 8B are flow diagrams of a technique for performing automatic and manual searches for games to be included in the gaming activity center.

Referring to FIG. 8A, at 810, a user starts an “Add Games” task in the illustrated example. At 812, an automatic search or a manual search is selected. The automatic search will look through the user's start menu for applications. In this example, at 814, the automatic search proceeds by looking in the computer's “start menu” and on the computer's desktop for executable files. It excludes a list of well-known non-gaming applications. At 816, fingerprints are created and batched and sent to a games metadata service (e.g., locally or over a network) for verification. At 818, a determination is made as to whether any matches are found. If matches are not found, the user has the option, at 820, to choose to perform a manual search (822). If matches are found, the games metadata service returns games metadata at 824 and displays results at 826. On a results page, the user will be presented with any titles that were a positive match, indicating that they are games and can be added to the gaming activity center. The user has the option at 828 to choose to manually add titles.

FIG. 8B illustrates a manual search 822. In a manual search, when the user selects a title to add, the application fingerprint, and if available, the shortcut link are obtained at 832 and are sent, at 834, to the games metadata service for verification. At 836, if the fingerprint is recognized, the service will return the WMID as well as metadata for the application at 838. If the fingerprint is not recognized and a shortcut link was provided by the gaming activity center (840), the service takes the shortcut link name and attempts a fuzzy text match against titles in the database. At 842, if any possible titles are found, a list of possible matches is sent to the client and displayed to the user at 844, ranked in order of a confidence score provided by the service. At 846, if the user chooses a title from the list, the client will make a request on behalf of the selected application's WMID for metadata. A backend can store the relation between the selected title/WMID and the fingerprint initially sent by the client. If none of the possible matches returned satisfy the user, a free-form title search user interface is displayed at 848, and the user will have the option to do a free form title search at 850. The service will execute a fuzzy title match based on the user input and, at 852, if possible matches are found, return a list of possible matches to the client. The client displays results to the user at 854, ranked in order of a confidence score provided by the service At 856, if the user chooses a title from the list, the client will make a request on behalf of the selected WMID for metadata. If none of the possible matches returned satisfy the user, the user will have the option to input information about the title that will then be transmitted to the service. At 858, a user feedback user interface is displayed. User-entered feedback data is saved at 860 and then sent to the games metadata service at 862.

To retrieve game metadata, the gaming activity center queries a metadata service (e.g., using a WMID or a fingerprint) to get extended information about the game. This metadata can then be displayed on the game's detail page. Game metadata can include a variety of information associated with a game, such as editorial recommendations for similar games, game play instructions, editorial reviews, rating information for parental control purposes (e.g., ESRB ratings), etc.

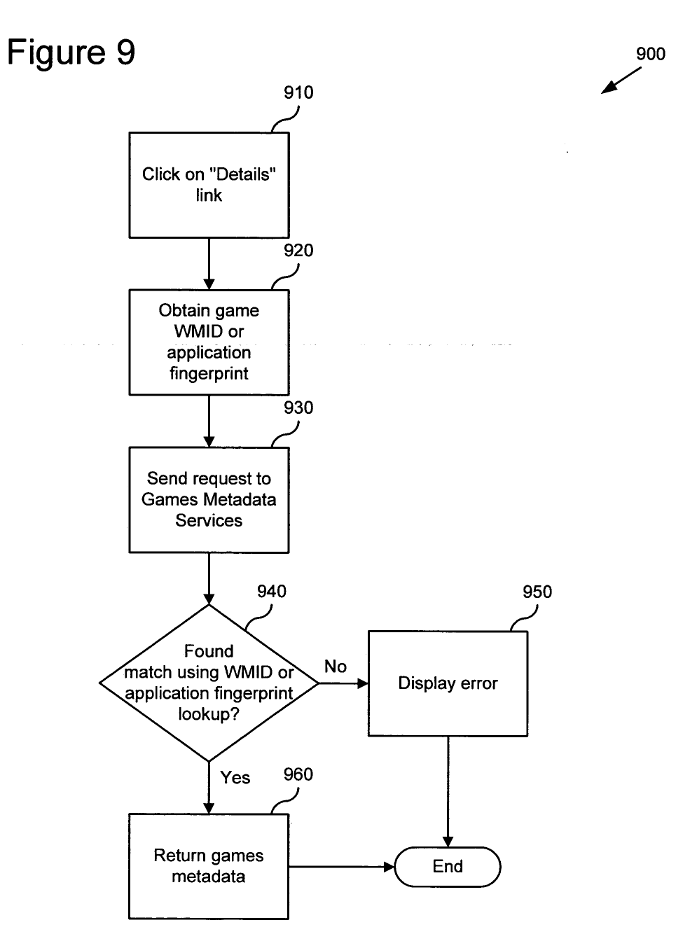

FIG. 9 is a flow diagram of a technique 900 for requesting game metadata using application fingerprints. At 910, a user clicks on a “Details” link for a game (e.g., a game listed in game library window 710). At 920, a fingerprint or WMID, if available, for the game is obtained, and a request to games metadata services is sent at 930. If a match for the game is not found (940), an “error” message is displayed (e.g., a message informing the user that no match was found) at 950. If a match is found, games metadata is returned to the client at 960.

Having described and illustrated the principles of our invention with reference to the described techniques and tools, it will be recognized that the described techniques and tools can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described implementations shown in software may be implemented in hardware and vice versa.

In view of the many possible embodiments to which the principles of our invention may be applied, we claim as our invention all such embodiments as may come within the scope and spirit of the following claims and equivalents thereto.

1. In a computer system, a method of generating an application identifier for a software application, the method comprising:
applying an identifier generation algorithm to application data for the software application, the application data for the software application comprising graphical icon data for the software application; and
generating an application identifier for the software application based on the applying of the identifier generation algorithm, the application identifier operable to distinguish the software application from other software applications on a computer system.

2. The method of claim 1 wherein the identifier generation algorithm is a hashing algorithm.

3. The method of claim 2 wherein the hashing algorithm is a one-way hashing algorithm.

4. The method of claim 2 wherein the application identifier is a 20-byte hash value.

5. The method of claim 1 wherein the graphical icon data is obtained from an application binary.

6. The method of claim 1 wherein the graphical icon data is obtained from an icon file.

7. The method of claim 1 further comprising comparing the application identifier with a list of application identifiers to determine an attribute of the software application.

8. The method of claim 7 wherein the attribute comprises a parental control rating for the software application.

9. The method of claim 1 further comprising sending the application identifier in a database query.

10. The method of claim 9 wherein a database receives the database query, and wherein the database returns results indicating whether metadata relating to the software application can be obtained from a metadata service.

11. The method of claim 9 wherein a database receives the database query, and wherein the database returns results indicating whether the software application is of a particular application type.

12. The method of claim 1 wherein the application data further comprises a name of the software application.

13. The method of claim 12 wherein the name is a name of an executable file.

14. The method of claim 1 wherein the application identifier is a unique fixed-length string.

15. The method of claim 1 further comprising storing the application identifier in a data file along with one or more other application identifiers for other software applications.

16. The method of claim 1 wherein the applying of the identifier generation algorithm comprises using functions included in application programming interface.

17. The method of claim 1 wherein the application data further comprises registry data.

18. The method of claim 1 wherein the software application is a gaming-related software application.

19. A computer-readable, program-carrying medium having carried thereon computer program code for performing the method of claim 1.

20. In a computer system, a method of generating an application identifier for a computer gaming-related software application, the method comprising:
applying a hashing algorithm to distinct application binary data for the gaming-related software application; and
generating a hash value based on the applying of the hashing algorithm to the distinct application binary data, where the hash value is a unique game identifier for the gaming-related software application, the unique game identifier for use in displaying information associated with the gaming-related software application in a graphical user interface-based gaming activity center.

21. The method of claim 20 wherein the hashing algorithm is a one-way hashing algorithm.

22. The method of claim 20 wherein the graphical user interface-based gaming activity center is a feature of an operating system.

23. In a computer system, a method of querying a database using an application identifier, the method comprising:
obtaining an application identifier for a software application, where the application identifier is a hash value generated by a hashing algorithm, the hash value based on distinct application binary data comprising graphical icon data for the software application;
sending a query to the database, the query comprising application identifier information; and
receiving a response to the query from the database.

24. The method of claim 23 wherein the database comprises a list of gaming-related software applications, and wherein the response to the query comprises an indicator of whether the software application is a gaming-related software application.

25. The method of claim 23 wherein the query to the application database comprises a request for metadata relating to the software application, and wherein the response to the query comprises metadata relating to the software application.

26. The method of claim 23 wherein the query to the application database comprises a request for parental control information relating to the software application, and wherein the response to the query comprises parental control information relating to the software application.

27. A computer system comprising:
means for obtaining icon data for a software application;
means for creating an application fingerprint for the software application; the creating based on the obtained icon data for the software application, the creating comprising applying a hashing algorithm to the obtained icon data.
